(19) United States
(12) Patent Application Publication
(10) Pub. No.: US 2025/0389550 A1
(43) Pub. Date: Dec. 25, 2025

(54) MAGNETOSTRICTIVE DISPLACEMENT SENSOR HAVING PROGRAMMABLE MEMORY

(71) Applicant: Temposonics, LLC, Cary, NC (US)

(72) Inventors: Frank Kraehe, Morrisville, NC (US); Wallace Pasour, Haw River, NC (US)

(21) Appl. No.: 19/247,288

(22) Filed: Jun. 24, 2025

Related U.S. Application Data
(60) Provisional application No. 63/663,959, filed on Jun. 25, 2024.

(51) Int. Cl. G01D 5/20

(52) U.S. Cl. CPC G01D 5/20

(57) ABSTRACT

One example of the sensor assembly includes an energy storage capacitor, a waveguide, a pickup, and a memory circuit. The energy storage capacitor is connected between a first supply voltage input/output and an electrical common input and is configured to maintain a supply voltage. The waveguide includes an input end connected to a current pulse input, and a return end connected to the electrical common input. The pickup is configured to output a response signal to a sensor output in response to a magnetostrictive response in the waveguide that is produced in response to a current pulse received at the current pulse input. The memory circuit is configured to store data, transmit the stored data through the first supply voltage input/output, and receive data for storage through the first supply voltage input/output.

### CROSS-REFERENCE TO RELATED APPLICATION(S)

The present application is based on and claims the benefit of U.S. provisional patent application Ser. No. 63/663,959, filed Jun. 25, 2024, the content of which is hereby incorporated by reference in its entirety.

### FIELD

Embodiments of the present disclosure generally relate to magnetostrictive displacement sensors, and more specifically, to magnetostrictive displacement sensors having a programmable memory for storing data, such as sensor calibration parameters.

### BACKGROUND

Magnetostrictive displacement sensors are robust, high resolution instruments which have proven to be useful in many measurement and control applications. Magnetostrictive displacement sensors generally include a sensor assembly, a target magnet and sensor electronics.

The sensor assembly generally includes a waveguide (e.g., conductive wire) and a pickup. The target magnet has a variable position along the waveguide corresponding to the position to be measured. The sensor electronics includes an excitation generator circuit that generates an excitation signal, such as a current pulse, which is conducted through the waveguide.

The excitation signal creates a magnetic field around the waveguide that interacts with the magnetic field of the target magnet to create a magnetostrictive response in the waveguide at the location of the target magnet. The magnetostrictive response takes the form of a sonic wave having mechanical pulse components including a longitudinal wave corresponding to a compression of the waveguide along its longitudinal axis, and a torsional wave corresponding to a torsional strain on the surface of the waveguide around the longitudinal axis.

The pickup is located at an end of the waveguide and includes a transducer or sensing element that is used to detect the longitudinal wave or torsional wave by converting the wave into an electrical response signal. The electrical response signal is processed to determine the position of the target magnet based on a time of flight measurement between the excitation signal and a detection of the longitudinal wave or the torsional wave. The location of the target magnet along the waveguide is determined based on this time of flight measurement.

Magnetostrictive displacement sensors are typically calibrated at the time of manufacture to account for variations in the performance of the system and establish calibration parameters that allow for accurate calculations of the position of the target magnet based on detected response signals and time of flight measurements. The calibration parameters are unique to the sensor assembly and may include, for example, the flight times for the null and span positions, offset values, magnetostrictive response propagation velocities, entries for response signal amplitude, a stroke length of the sensor, a form factor, and/or other calibration parameters.

The calibration parameters are typically stored in a database, and users may obtain the calibration parameters for a particular sensor from the database using a unique identification code for the sensor. The obtained calibration parameters may then be programmed in a measurement device (e.g., process level transmitter) utilizing the sensor at the time of manufacture to ensure accurate target magnet position measurements.

Some measurement devices allow for the replacement of the magnetostrictive displacement sensor from a measurement device. As a result, the measurement device must be recalibrated to include the calibration parameters of the new magnetostrictive sensor. This generally requires obtaining the calibration parameters for the new sensor from the database using the unique identification code of the new sensor and programming the measurement device with the obtained calibration parameters, which can be time consuming.

Additionally, some users are not trained or equipped to perform this sensor replacement and device reprogramming. As a result, such users must send the device back to the manufacturer to have the necessary work performed, resulting in a significant amount of time that the measurement device is out of service.

Furthermore, the manual process of obtaining the calibration parameters and programming the measurement device is prone to errors, which may prevent the measurement device from operating properly or producing accurate measurements.

### SUMMARY

Embodiments of the present disclosure are generally directed to sensor assemblies of a magnetostrictive displacement sensor having a programmable memory for storing data, magnetostrictive displacement sensors that include the sensor assembly, and methods of operating the magnetostrictive displacement sensor.

One example of the sensor assembly includes an energy storage capacitor, a waveguide, a pickup, and a memory circuit. The energy storage capacitor is connected between a first supply voltage input/output and an electrical common input and is configured to maintain a supply voltage. The waveguide includes an input end connected to a current pulse input, and a return end connected to the electrical common input. The pickup is configured to output a response signal to a sensor output in response to a magnetostrictive response in the waveguide that is produced in response to a current pulse received at the current pulse input. The memory circuit is configured to store data, transmit the stored data through the first supply voltage input/output, and receive data for storage through the first supply voltage input/output.

One example of the magnetostrictive displacement sensor includes a sensor assembly, sensor electronics, and a connector that forms electrical connections between the sensor assembly and the sensor electronics. The sensor assembly includes an energy storage capacitor connected between a first supply voltage input/output and an electrical common input and is configured to maintain a supply voltage, a waveguide having an input end connected to a current pulse input, and a return end connected to the electrical common input, a pickup configured to output a response signal to a sensor output in response to a magnetostrictive response in the waveguide produced in response to a current pulse received at the current pulse input, and a memory circuit powered by the supply voltage and configured to transmit and receive data through the first supply voltage input/output. The sensor electronics includes an electrical common output, a supply voltage driver circuit, an excitation generator circuit, and a controller. The controller is configured to send and receive supply voltage signals through a second supply voltage input/output using the supply voltage driver circuit, deliver the current pulse to a current pulse output and receive the response signal through a sensor input. The connector is configured to connect the second supply voltage input/output to the first supply voltage input/output, the current pulse output to the current pulse input, the electrical common output to the electrical common input, and the sensor input to the sensor output.

In one example of a method of operating a magnetostrictive displacement sensor, the sensor includes a sensor assembly having an energy storage capacitor connected between a first supply voltage input/output and an electrical common input, a waveguide having an input end connected to a current pulse input and a return end connected to the electrical common input, a pickup, and a memory circuit connected to the first supply voltage input/output and containing stored data. In the method, supply voltage signals are received at the first supply voltage input/output. A supply voltage is maintained across the energy storage capacitor using the received supply voltage signals. The memory circuit is powered using the supply voltage. The stored data is communicated through the first supply voltage input/output using the memory circuit. A magnetostrictive response is generated in the waveguide in response to a current pulse received through the current pulse input. A response signal is delivered to a sensor output in response to the magnetostrictive response using the pickup.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIGS. 1 and 2 respectively are a schematic pictorial view and a simplified circuit diagram of an example of a magnetostrictive displacement sensor, in accordance with embodiments of the present disclosure.

FIGS. 3A-D are isometric views of examples of pickups, in accordance with embodiments of the present disclosure.

FIG. 4 is a simplified circuit diagram of a magnetostrictive sensor comprising a sensor assembly and sensor electronics, in accordance with embodiments of the present disclosure.

FIG. 5 is a flowchart illustrating a method of operating a magnetostrictive displacement sensor, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the specific embodiments set forth herein. Rather, embodiments are described so that this disclosure will be thorough and complete, and will fully convey the scope of the embodiments to those skilled in the relevant art.

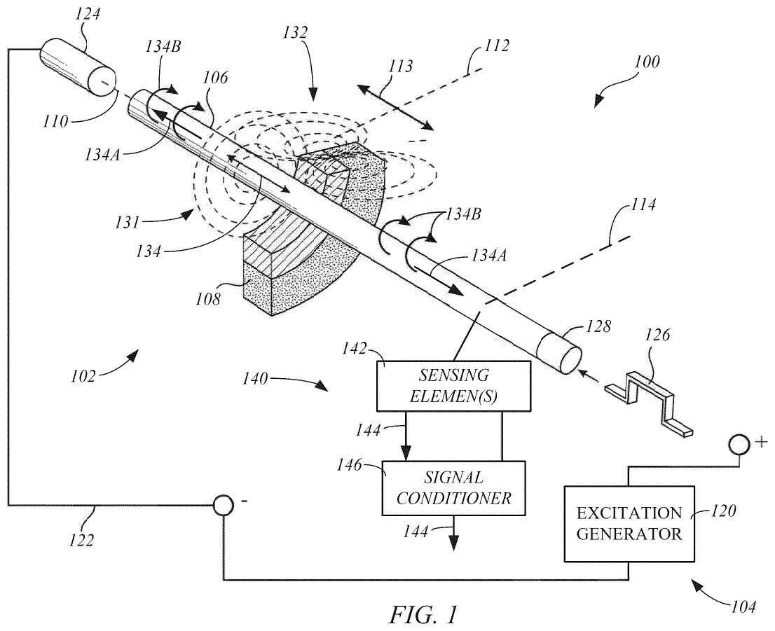

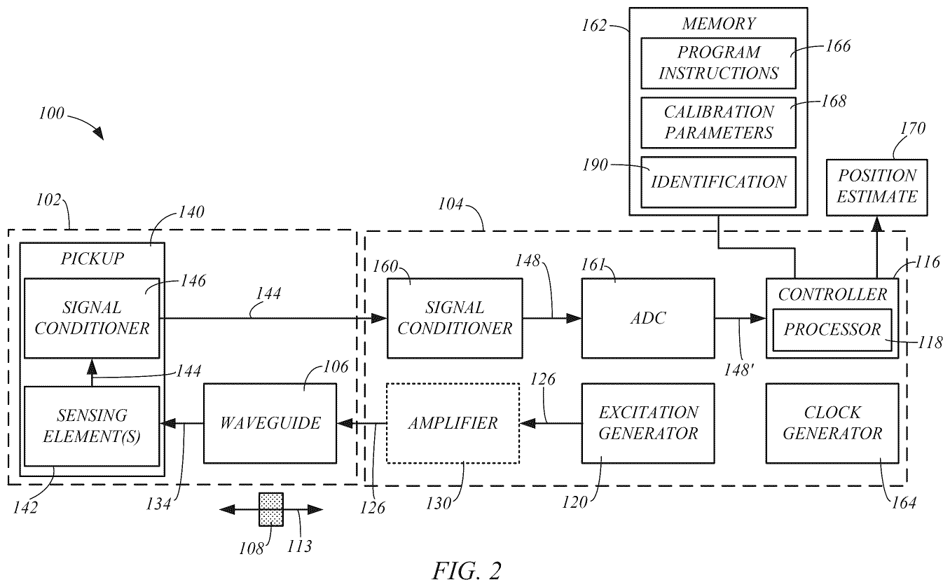

FIGS. 1 and 2 respectively are a schematic pictorial view and a simplified circuit diagram of an example of a magnetostrictive displacement sensor (MDS) 100, in accordance with embodiments of the present disclosure. The MDS 100 includes a sensor assembly 102 and sensor electronics 104. The sensor assembly 102 includes a wire having magnetoelastic properties, referred to as a waveguide 106 and a pickup.

At least one target magnet 108 is located near the waveguide 106 and has a position 112 that is adjustable along an axis 110 of the waveguide 106, as indicated by arrow 113. The target magnet 108 may take the form of a bar magnet positioned alongside the waveguide 106, a ring magnet that surrounds the waveguide 106, or another suitable form. The MDS 100 is generally configured to measure the position 112 of the target magnet 108 along the waveguide 106 relative to a reference position 114.

The sensor electronics 104 includes a controller 116 having one or more processors 118, and an excitation generator circuit 120 that is connected to the waveguide 106. A closed electrical circuit may be formed by the excitation generator circuit 120, the waveguide 106, and a return wire 122 that connects a distal end 124 of the waveguide 106 back to the excitation generator circuit 120, as shown in FIG. 1. The controller 116 uses the excitation generator circuit 120 to generate an electrical current pulse 126 that is delivered to a proximal end 128 of the waveguide 106. An amplifier 130 (FIG. 2) of the sensor electronics 104 may be used to amplify the current pulse 126 before applying it to the waveguide 106.

The transmission of the current pulse 126 through the waveguide 106 generates a magnetic field 131 that interacts with the magnetic field 132 of the magnet 108 to generate a mechanical magnetostrictive response (e.g., acoustic waves) 134 in the waveguide 106, which includes a longitudinal wave 134A (e.g., longitudinal compression) and a torsional wave 134B (e.g., torsional strain), as indicated in FIG. 1.

The magnetostrictive response 134 travels from both sides of the magnet 108 along the waveguide 106. For example, a portion of the magnetostrictive response 134 may travel along the waveguide 106 from the position 112 of the magnet 108 toward the end 124 and possibly to a damper (not shown) that reduces or eliminates propagation of the acoustic waves 134 back through the waveguide 106. Additionally, a portion of the magnetostrictive response 134 travels from the position 112 of the magnet 108 toward the end 128, at which a magnetostrictive response pickup 140 is used to sense the magnetostrictive response 134, such as the longitudinal wave 134A and/or the torsional wave 134B.

The pickup 140 includes one or more sensing elements 142 that are configured to sense the magnetostrictive response 134 and generate at least one electrical response signal 144 that is based on the magnetostrictive response 134. That is, the electrical response signal or signals 144 includes an indicator of the longitudinal wave 134A and/or an indicator of the torsional wave 134B. The one or more indicators may comprise a transient change or pulse in the magnitude of the signal 144, for example. The indicators may be detected by the controller 116 to determine the position 112 of the target magnet 108 based on the time from when the current pulse 126 is generated to when the indicator of the magnetostrictive response is detected in the signal 144 using conventional techniques.

A signal conditioner 146 of the pickup 140 may be used to isolate the sensing element 142 from electrical interference and condition (e.g., amplify, rectify, filter, etc.) the signals 144 before delivering a conditioned response signal 144 to the sensor electronics 104, as indicated in FIG. 2. Thus, in some embodiments, the conditioned response signal 144 from the pickup 140 may be the original signal 144 generated by the sensing element(s) 142, such as when the pickup 140 does not include the signal conditioner 146, or the response signal 144 after being conditioned or processed by the circuitry of the signal conditioner 146.

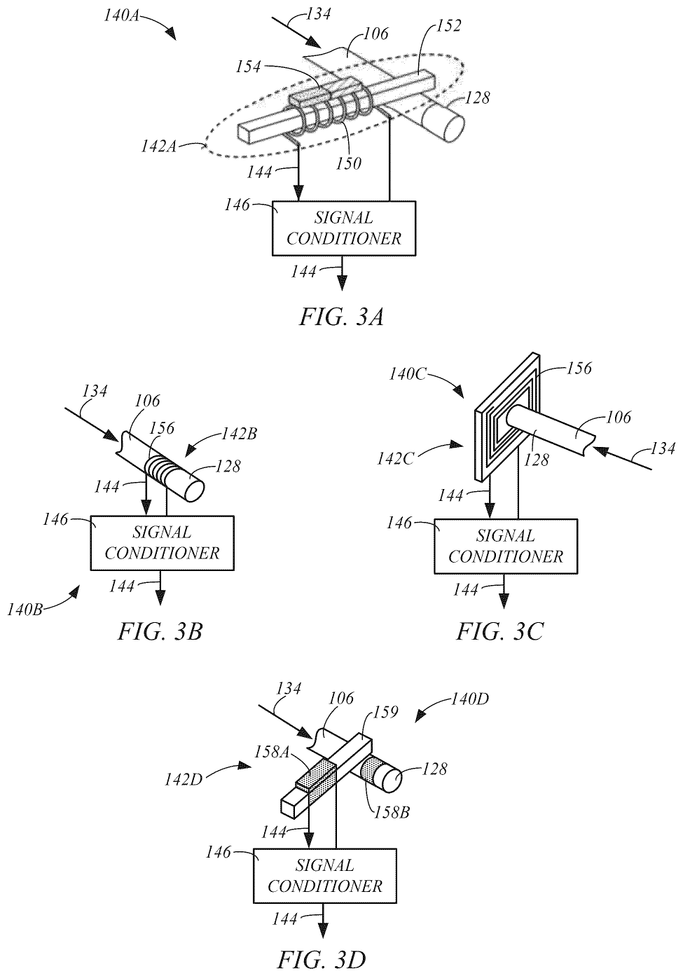

The sensing element 142 may take on any suitable form. FIGS. 3A-D are isometric views of examples of pickups 140A-D, in accordance with embodiments of the present disclosure. The example sensing element 142A includes a coil 150 that is attached to the waveguide 106, such as through a rigid member 152, as shown in FIG. 3A. A magnet 154 has a magnetic field that surrounds the coil 150. When the magnetostrictive response 134 (e.g., longitudinal wave or torsional wave) traveling through the waveguide 106 reaches the member 152, the member 152 vibrates causing relative movement between the magnetic field and the coil 150. The magnetic field induces a current pulse in the coil 150, which forms the indicator 144 of the response 134 in the electrical response signal 144 traveling through the coil 150. The signal 144 from the coil 150 may be processed by the signal conditioner 146 before reaching the controller 116 (FIG. 2).

One alternative to this arrangement is to form the member 152 out of a magnetic material and support the coil 150 in a manner that allows the magnetic member 152 to move relative to the coil 150. Thus, when the magnetic member 152 vibrates in response to the magnetostrictive response 134, a corresponding current pulse indicator is induced in the electrical response signal 144 from the coil 150 due to the movement of the magnetic field relative to the coil 150.

The sensing element 142 may include a conductive coil 156 that is wrapped around the waveguide 106 to form the example sensing element 142B shown in FIG. 3B, or the conductive coil 156 may be oriented in a plane that is generally perpendicular to the waveguide 106 to form the example sensing element 142C shown in FIG. 3C. In each case, the magnetostrictive response 134 traveling through the waveguide induces a current pulse or indicator in the response signal 144 traveling through the coil 156.

The example sensing element 142D shown in FIG. 3D comprises a piezoelectric material 158 that is connected to the waveguide 106 and is configured to be physically strained in response to the magnetostrictive response 134. The strain on the piezoelectric material 158 produces a current pulse in the response signal 144 that forms an indicator 144 of the response 134. The piezoelectric material 158 may be exposed to the magnetostrictive response 134 through a piezoelectric material 158A that is connected to a side of the waveguide through a rigid member 159, or a piezoelectric material 158B that is connected to or in line with the waveguide 106, for example.

The sensor electronics 104 may process the one or more response signals 144 using any suitable technique. The sensor electronics 104 may include a signal conditioner 160 instead of, or in addition to, the signal conditioner 146 of the pickup 140. As with the signal conditioner 146, the signal conditioner 160 includes circuitry that amplifies, rectifies, filters, compares and/or performs another conventional process on the response signal 144, and supplies a processed response signal 148 to an analog-to-digital converter (ADC) 161 of the sensor electronics. The ADC 161 converts each of the one or more analog electrical response signals 148 into corresponding digital samples 148′. For example, the ADC 161 may sample each of the one or more analog response signals 148 at a frequency that allows the response signal 148 to be further processed by the controller 116. The digital samples 148′ of each response signal 148 may be stored in non-transitory memory 162 of the MDS 100, such as a buffer or memory of the controller 116, for example.

The sensor electronics 104 may include a clock generator 164 that begins a timing routine when the current pulse 126 is generated by the excitation generator circuit 120. The clock generator 164 may be used to determine the time of each digital sample 148′ relative to the generation of the current pulse 126, in accordance with conventional techniques.

The one or more processors 118 of the controller 116 control components of the MDS 100 (e.g., excitation generator circuit 120), and/or perform one or more functions described herein in response to the execution of program instructions 166 and calibration parameters 168 stored in the memory 162, which is computer-readable media (e.g., flash memory, optical data storage, magnetic data storage, etc.). The memory 162 may represent memory of the sensor electronics 104, the sensor assembly 102 and/or memory of a measurement device (e.g., process level transmitter) that utilizes the MDS 100.

Each processor 118 of the controller 116 may comprise one or more computer-based systems, control circuits, microprocessor-based engine control systems, and/or programmable hardware components (e.g., field programmable gate array), for example. While the controller 116 is shown as being a component of the sensor electronics 104, it is understood that the controller 116 may represent one or more controllers and processors that are used within a measurement device to perform one or more functions described herein.

In some embodiments, the at least one processor 118 is configured to analyze the digital samples 148′ of the response signal 148 to detect the indicator of the longitudinal wave 134A and/or the indicator of the torsional wave 134B, from which the position 112 of the target magnet 108 may be determined due to the known speed of the corresponding longitudinal acoustic wave 134A or torsional acoustic wave 134B through the waveguide 106 using the calibration parameters, in accordance with conventional techniques. The controller 116 may output a position estimate 170 that indicates the position 110.

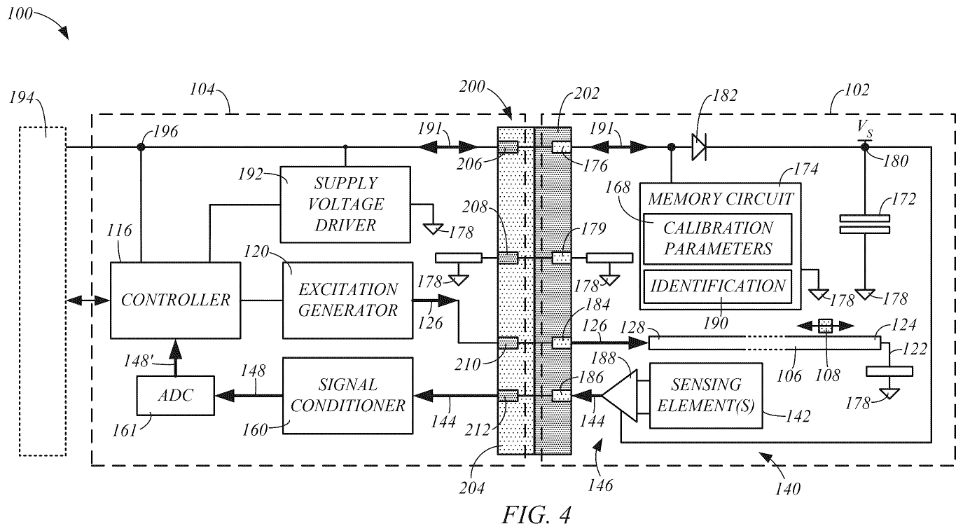

FIG. 4 is a simplified circuit diagram of a magnetostrictive sensor comprising a sensor assembly 102 and sensor electronics 104, in accordance with embodiments of the present disclosure. Embodiments of the present disclosure include the sensor assembly 102, an MDS 100 comprising the sensor assembly 102 and the sensor electronics 104, and methods of operating the MDS 100.

In one example, the sensor assembly 102 includes an energy storage capacitor 172, the waveguide 106, the pickup 140, and a memory circuit 174. The energy storage capacitor 172 represents one or more energy storage capacitors and is connected between a supply voltage input/output (I/O) 176 and an electrical common 178, which is connected to an electrical common input 179. The energy storage capacitor 172 is configured to maintain a supply voltage V_{S} (e.g., 3.3 V) at a node 180 of the circuit using electrical energy received through the supply voltage I/O 176. A diode 182 may be used to prevent the energy stored on the capacitor 172 from being discharged directly back to the supply voltage I/O 176.

The waveguide 106 and pickup 140 may take on any suitable form including those described above. The input end 128 of the waveguide 106 is connected to a current pulse input 184, and the return end 124 is connected to the electrical common 178. The sensing element 142 of the pickup 140 is configured to output a response signal 144 to a sensor output 186 in response to a magnetostrictive response in the waveguide 106 that is produced in response to a current pulse 126 received at the current pulse input 184, and a position of the target magnet 108 along the axis of the waveguide 106, as discussed above.

As mentioned above, the signal conditioner 146 of the pickup 140 may be configured to isolate the sensing element 142 from electrical interference and condition (e.g., amplify, filter, etc.) the response signal 144. Since the sensing element 142 (e.g., coil) may have a very high impedance (e.g., 50 kilo-ohms), the signal conditioner 146 may include a unity gain buffer circuit (e.g., a single-stage amplifier) that includes an operational amplifier 188 that is used to reduce the impedance at which the response signal 144 is conducted at the sensor output 186, such as down to 100 ohms, for example, and isolate the response signals 144 from electrical interference. Components of the signal conditioner 146, such as the operational amplifier 188, and other components of the sensor assembly 102 may be powered using the supply voltage V_{S} across the capacitor 172.

The memory circuit 174 may take on any suitable conventional form and may include a controller and/or a processor for executing program instructions, such as in response to received commands, to perform various functions including storing data and communicating stored data. The memory circuit 174 includes non-transitory memory, such as that described above, for storing data. One example of a suitable memory circuit 174 is the 11LC160T memory circuit produced by Microchip.

In some embodiments, the memory circuit 174 is configured to store data received through the supply voltage I/O 176 in its memory and transmit the stored data through the supply voltage I/O 176. In some embodiments, the stored data contained in the memory circuit 174 includes calibration parameters 168 for the sensor assembly 102, which may be obtained and stored in the memory circuit 174 at the time of manufacture. The calibration parameters are unique to the sensor assembly 102 and may include, for example, the flight times for the null and span positions, offset values, magnetostrictive response propagation velocities, entries for response signal amplitude, a stroke length of the sensor, a form factor, and/or other calibration parameters. The memory circuit 174 may also include an identification 190 of the sensor assembly 102, such as a serial number, a model number and/or other information that identifies the sensor assembly 102.

Data may be stored and/or retrieved in the memory circuit over the supply voltage I/O 176 using conventional techniques. In one embodiment, data is communicated using supply voltage signals 191 at the supply voltage I/O 176. For example, the supply voltage I/O 176 may normally be held at a high voltage value (e.g., V_{S}) to charge the capacitor 172, and data is communicated between the memory circuit 174 and the controller 116 of the sensor electronics 104 through the supply voltage I/O 176 by pulling the supply voltage I/O 176 to a logic low voltage value, which may represent a digital “0” value, while the high voltage value represents a digital “1” value. Thus, the controller 116 of the sensor electronics 104 and/or the memory circuit 174 may operate to modulate the supply voltage signal 191 at the supply voltage I/O 176 to communicate data, while also maintaining the supply voltage V_{S} across the capacitor 172.

Embodiments of the sensor electronics 104 may include one or more components described above. For example, the sensor electronics 104 may include the excitation generator circuit 120 and the controller 116 that is configured to control the excitation generator circuit 120 to deliver the current pulse 126 to the current pulse input 184 for transmission through the waveguide 106.

The sensor electronics 104 also includes a supply voltage driver circuit 192, which may be controlled by the controller 116 to send and receive the supply voltage signals 191 through the supply voltage I/O 176. The supply voltage driver circuit 192 may utilize electrical power (e.g., supply voltage V_{S}) received from the electronics 194 of a measurement device utilizing the MDS 100 at a node 196 and modulate this power to provide the supply voltage signals 191 at the supply voltage I/O 176, using conventional techniques, to issue commands or communicate data to the memory circuit 174.

In one example, the controller 116 issues a command to the memory circuit 174 instructing it to send one or more of the calibration parameters 168 for the sensor assembly 102. This command may be issued to the supply voltage I/O 176 through the modulation of the supply voltage signals 191 using the supply voltage driver circuit 192 by pulling the voltage at the supply voltage I/O 176 to the low voltage value, for example. The memory circuit 174 may be configured to respond to the command by similarly modulating the voltage at the supply voltage I/O 176 using conventional techniques to transmit the calibration parameters 168 to the controller 116. The received calibration parameters 168 may then be used by the controller 116 of the sensing electronics 104 or the device electronics 194 to process the response signals 144 issued by the pickup 140 and generate the position estimate 170 for the target magnet 108. In some embodiments, the issuance of the command and the communication of the calibration parameters 168 occurs during an initialization operation, such as when the sensor electronics 104 and sensor assembly 102 are connected together and powered up using the power at the node 196, for example.

In some embodiments, the sensor assembly 102 may be connected to the sensor electronics 104 using a connector 200. The connection facilitated by the connector 200 includes the electrical connections described below. In some embodiments, the connector 200 may also facilitate a connection between a housing supporting the sensor assembly 102 and a housing supporting the sensor electronics 104.

In one example, the connector 200 includes a connector portion 202 that is attached to the sensor assembly 102 and a connector portion 204 that is attached to the sensor electronics 104. The connector portions 202 and 204 allow for the separation of the sensor assembly 102 from the sensor electronics 104, such as when the sensor assembly 102 requires replacement. In that case, a new sensor assembly 102 having a corresponding connector portion 202 may be attached to the sensor electronics 104. The calibration parameters 168 of the new sensor assembly 102 may be communicated to the sensor electronics 104 as discussed above to ensure accurate position estimates 170. In some embodiments, the sensor identification 190 is also communicated to the sensor electronics 104 through the supply voltage I/O 176 either along with the calibration parameters 168, or in response to a different command from the controller 116, for example.

One example of the connector portion 202 includes the supply voltage I/O 176, the electrical common input 179, the current pulse input 184 and the sensor output 186.

One example of the connector portion 204 includes a supply voltage I/O 206 connected to the node 196, an electrical common output 208, a current pulse output 210 configured to receive the current pulse 126 from the excitation generator circuit 202, and a sensor input 212. The electrical common output 208 is connected to the electrical common 178, which may be provided by the circuitry of the sensor electronics 104 or a connection to the device electronics 194, for example.

When the connector portions 202 and 204 are connected together, such as using a conventional mechanical fastening technique (e.g., threaded connection, latched connection, etc.), the supply voltage I/O 206 is connected to the supply voltage I/O 176, the current pulse output 210 is connected to the current pulse input 184, the electrical common output 208 is connected to the electrical common input 179, and the sensor input 212 is connected to the senor output 186. Thus, when the connector 200 is assembled, the sensor assembly 102 is connected to the sensor electronics 104 in a manner that allows for communication of the various signals discussed above.

One advantage of the sensor assembly 102 and embodiments of the MDS 100 shown in FIG. 4 is that only four conductors/connections are required between sensor assembly 102 and the sensor electronics 104. As a result, the size of the sensor assembly 102, the connector 200, and the sensor electronics 104 may be reduced over those requiring additional conductors to operate. This allows for the formation of smaller MDS's 100, which increases the applications for the MDS 100.

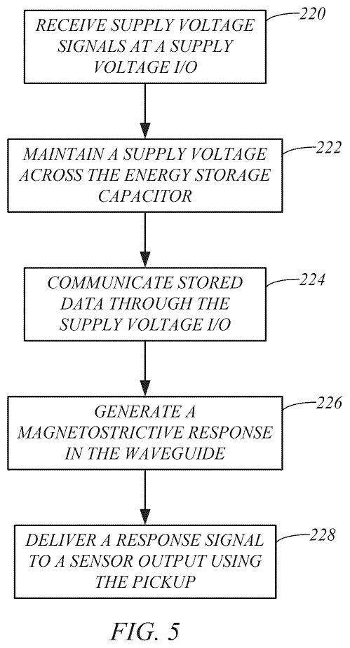

FIG. 5 is a flowchart illustrating a method of operating the MDS 100, in accordance with embodiments of the present disclosure. In some embodiments, the MDS 100 is formed in accordance with one or more embodiments described above, such as those shown in FIG. 4. Thus, the MDS 100 may comprise the energy storage capacitor 172, the waveguide 106, the pickup 140 and the memory circuit 174.

At 220 of the method, supply voltage signals 191 are received at the supply voltage I/O and a supply voltage V_{S} is maintained across the energy storage capacitor 172 using the received supply voltage signals 191 at 222. The memory circuit 174 is powered by the supply voltage V_{S}. At 224, stored data, such as the calibration parameters 168 and/or the supply assembly identification 190, is communicated through the supply voltage I/O 176 using the memory circuit 174.

At 226, a magnetostrictive response 134 (FIG. 1) is generated in the waveguide 106 in response to a current pulse 126 received through the current pulse input 184. The magnetostrictive response 134 is generated by a target magnet 108 that is located along an axis 110 of the waveguide 106, as discussed above with reference to FIG. 1. At 228, a response signal 144 is delivered to the sensor output 186 in response to the magnetostrictive response using the pickup 140, such as after processing of the response signal 144 using a signal conditioner 146, for example.

In some embodiments, the MDS 100 includes the sensor electronics 104 formed in accordance with one or more embodiments described herein including those discussed above with reference to FIG. 4. In one example, the sensor electronics 104 includes the electrical common output 208 that is connected to the electrical common 178 and the electrical common input 178, the supply voltage driver circuit 192 connected to the supply voltage I/O 176, the excitation generator circuit 120 connected to the current pulse input 184, and the controller 116.

Some embodiments of the method include generating the supply voltage signals 191 received in step 220 using the supply voltage driver circuit 192 and delivering the supply voltage signals 191 to the supply voltage input/output 176 through the supply voltage input/output 206. The current pulse 126 may be generated using the excitation generator circuit 120 and delivered to the current pulse input 184 through the current pulse output 210. Additionally, the controller 116 may receive the stored data communicated from the memory circuit 174 in step 224 through the supply voltage I/O 206. The communicated data may include one or more calibration parameters 168 and/or the sensor assembly identification 190. It is understood that the communication step 224 may be performed before the step of generating the current pulse 126 and the step 226 of generating the magnetostrictive response, such as upon startup of the MDS 100, as discussed above.

Although the embodiments of the present disclosure have been described with reference to preferred embodiments, workers skilled in the art will recognize that changes may be made in form and detail without departing from the spirit and scope of the present disclosure.

Functions recited herein may be performed by a single controller or processor, multiple controllers or processors, or at least one controller or processor. As used herein, when one or more functions are described as being performed by a controller (e.g., a specific controller), one or more controllers, at least one controller, a processor (e.g., such as a specific processor), one or more processors or at least one processor, embodiments include the performance of the function(s) by a single controller or processor, or multiple controllers or processors, unless otherwise specified. Furthermore, as used herein, when multiple functions are performed by at least one controller or processor, all of the functions may be performed by a single controller or processor, or some functions may be performed by one controller or one processor, and other functions may be performed by another controller or processor. Thus, the performance of one or more functions by at least one controller or processor does not require that all of the functions are performed by each of the controllers or processors, or by a single one of the controllers or processors.

What is claimed is:

1. A magnetostrictive displacement sensor including a sensor assembly comprising:
an energy storage capacitor connected between a first supply voltage input/output and an electrical common input and configured to maintain a supply voltage;
a waveguide having an input end connected to a current pulse input, and a return end connected to the electrical common input;
a pickup configured to output a response signal to a sensor output in response to a magnetostrictive response in the waveguide produced in response to a current pulse received at the current pulse input; and
a memory circuit configured to store data, transmit the stored data through the first supply voltage input/output, and receive data for storage through the first supply voltage input/output.

2. The sensor according to claim 1, wherein the memory circuit comprises stored data including an identification of the sensing element and/or one or more calibration parameters.

3. The sensor according to claim 2, wherein the pickup includes a sensing element configured to generate the response signal comprising:
a sensor magnet and a coil, wherein relative movement between the magnet and the coil in response to the magnetostrictive response generates the response signal in the coil; or
a piezoelectric material configured to generate the response signal in response to a mechanical stress on the piezoelectric material caused by the magnetostrictive response.

4. The sensor according to claim 2, wherein the pickup includes a buffer circuit configured to isolate the sensing element from electrical interference and deliver the response signal to the sensor output at a lower impedance than an impedance of the sensing element.

5. The sensor according to claim 4, wherein the buffer circuit includes an amplifier that receives the supply voltage from the energy storage capacitor.

6. The sensor according to claim 1, including a connector portion comprising the first supply voltage input/output, the electrical common input, the current pulse input and the sensor output.

7. The sensor according to claim 1, including sensor electronics comprising:
a supply voltage driver circuit;
an excitation generator circuit; and
a controller configured to:
send and receive supply voltage signals through the first supply voltage input/output using the supply voltage driver circuit; and
deliver the current pulse to the current pulse input using the excitation generator circuit.

8. The sensor according to claim 7, wherein the electronics assembly includes a signal conditioning circuit configured to condition the response signal for processing by the controller.

9. The sensor according to claim 7, wherein the memory circuit is configured to communicate stored data to the controller through the first supply voltage input/output.

10. The sensor according to claim 9, wherein the stored data includes an identification of the sensing element and/or one or more calibration parameters.

11. The sensor according to claim 9, including a connector comprising:
a first connector portion comprising the first supply voltage input/output, the electrical common input, the current pulse input and the sensor output; and
a second connector portion comprising:
a second supply voltage input/output connected to the supply voltage driver circuit;
an electrical common output connected to an electrical common;
a current pulse output configured to receive the current pulse; and
a sensor input connected to the controller,
wherein the first and second connector portions cooperate to connect the second supply voltage input/output to the first supply voltage input/output, the current pulse output to the current pulse input, the electrical common output to the electrical common input, and the sensor input to the sensor output.

12. The sensor according to claim 11, including a target magnet having a moveable position along an axis of the waveguide, wherein the magnetostrictive response is generated in the waveguide in response to an interaction between a magnetic field of the target magnet and a magnetic field of the current pulse.

13. A magnetostrictive displacement sensor comprising:
a sensor assembly comprising:
an energy storage capacitor connected between a first supply voltage input/output and an electrical common input and configured to maintain a supply voltage;
a waveguide having an input end connected to a current pulse input, and a return end connected to the electrical common input;
a pickup configured to output a response signal to a sensor output in response to a magnetostrictive response in the waveguide produced in response to a current pulse received at the current pulse input; and
a memory circuit powered by the supply voltage and configured to transmit and receive data through the first supply voltage input/output;
sensor electronics comprising:
an electrical common output;
a supply voltage driver circuit;
an excitation generator circuit; and
a controller configured to:
send and receive supply voltage signals through a second supply voltage input/output using the supply voltage driver circuit;
deliver the current pulse to a current pulse output; and
receive the response signal through a sensor input; and
a connector configured to connect the second supply voltage input/output to the first supply voltage input/output, the current pulse output to the current pulse input, the electrical common output to the electrical common input, and the sensor input to the sensor output.

14. The sensor according to claim 13, wherein:
the memory circuit comprises stored data including an identification of the sensing element and/or one or more calibration parameters; and
the controller is configured to receive the stored data through the second supply voltage input/output.

15. The sensor according to claim 14, wherein the connector comprises:
a first connector portion comprising the first supply voltage input/output, the electrical common input, the current pulse input and the sensor output; and
a second connector portion comprising:
the second supply voltage input/output/output;
the electrical common output;
the current pulse output; and
the sensor input,
wherein the first and second connector portions cooperate to connect the second supply voltage input/output to the first supply voltage input/output, the current pulse output to the current pulse input, the electrical common output to the electrical common input, and the sensor input to the sensor output.

16. The sensor according to claim 15, including a target magnet having a moveable position along an axis of the waveguide, wherein the magnetostrictive response is generated in the waveguide in response to an interaction between a magnetic field of the target magnet and a magnetic field of the current pulse.

17. A method of operating a magnetostrictive displacement sensor, which includes a sensor assembly comprising:
an energy storage capacitor connected between a first supply voltage input/output and an electrical common input;
a waveguide having an input end connected to a current pulse input, and a return end connected to the electrical common input;
a pickup; and
a memory circuit connected to the first supply voltage input/output and containing stored data,
the method comprising:
receiving supply voltage signals at the first supply voltage input/output;
maintaining a supply voltage across the energy storage capacitor using the received supply voltage signals;
powering the memory circuit using the supply voltage;
communicating the stored data through the first supply voltage input/output using the memory circuit;
generating a magnetostrictive response in the waveguide in response to a current pulse received through the current pulse input; and
delivering a response signal to a sensor output in response to the magnetostrictive response using the pickup.

18. The method according to claim 17, wherein the sensor includes a sensor electronics comprising:
an electrical common output connected to the electrical common input;
a supply voltage driver circuit connected to a second supply voltage input/output;
an excitation generator circuit connected to a current pulse input; and
a controller,
the method comprising:
generating the supply voltage signals using the supply voltage driver circuit and delivering the supply voltage signals to the first supply voltage input/output through the second supply voltage input/output;
generating the current pulse using the excitation generator circuit and delivering the current pulse to the current pulse input through the current pulse output; and
receiving, by the controller, the stored data from the memory circuit through the second supply voltage input/output.

19. The method according to claim 18, wherein the stored data includes an identification of the sensing element and one or more calibration parameters.

20. The method according to claim 19, wherein the sensor comprises a connector configured to connect the second supply voltage input/output to the first supply voltage input/output, the current pulse output to the current pulse input, the electrical common output to the electrical common input, and the sensor input to the sensor output.
